(19) United States
(12) Patent Application Publication
(10) Pub. No.: US 2007/0166116 A1
(43) Pub. Date: Jul. 19, 2007

(54) HOLE CUTTER AND GUIDE

(76) Inventors: Dennis L. Olson, Fairbanks, AK (US); Joel R. Borkovec, North Pole, AK (US)

Correspondence Address: ADVANTIA LAW GROUP, 9035 SOUTH 1300 EAST, SUITE 200, SANDY, UT, 84094, US

(21) Appl. No.: 11/306,995

(22) Filed: Jan. 18, 2006

(51) Int. Cl. B23B 51/04

(52) U.S. Cl. 408/204

(57) ABSTRACT

A hole cutter and guide for guiding the cutting of holes in a material, including a bit portion, upon which may be mounted a first hole saw, a spacer portion, and a second hole saw, wherein the first and second hole saws have different diameters, and are couplable to the bit portion. The bit portion may include posts that fit through the first hole saw, second hole saw, and spacer portion. The bit portion may include a threaded portion onto which the first and/or second hole saws may be coupled by a threaded portion in each of the first and second hole saws. Also disclosed is a kit having component parts capable of being assembled in the field, the component parts of which include the bit portion, first hole saw, spacer portion, and second hole saw.

### FIELD OF THE INVENTION

The present invention relates generally to hole cutters and guides and, more particularly, to hole cutters and guides for cutting holes or countersinking with a guide.

### DESCRIPTION OF THE RELATED ART

In U.S. Patent Application Publication 2005/0042048 Keightley discloses an improved hole-saw assembly and in particular, to a mandrel engageable by a drill and including at least one locking ring or annulus that allows for the base of two hole-saws of different diameter to be quickly and easily mountable and demountable from the mandrel. The hole-saw assembly includes a first hole-saw having a base that includes a pair of drive-pins extending outwardly therefrom and a pair of apertures for insertion therethrough of the drive pins of a second hole-saw. The drive pin pairs are then inserted through corresponding apertures in the mandrel to engage an annulus coupled to the mandrel. The present invention provides for each drive pin to be engaged by the annulus despite the difference in longitudinal length of the drive pins beyond the base of the first hole-saw. The hole-saws are snap-fit within the annulus and may be disengaged by simply rotating the annulus to a second position. A further embodiment of the present invention further allows one to insert the hole-saws into any one of the mandrel insertion points without being concerned about whether it contains the correct engaging means or not. A still further embodiment of the invention prevents slight longitudinal movement which is known to occur when the hole-saws are coupled to the mandrel.

Further, in U.S. Pat. No. 6,881,017, Krecek discloses a hole saw adaptor that would generally have a cylindrical configuration with a flattened portion on one end that allows it to be inserted into the hole saw arbor and locked into place with the set screw. The other end of the adaptor would include a threaded area similar to that on the lower end of any standard hole saw arbor. Thus, the hole saw used to cut the initial hole can be threaded onto this end of the adaptor, with the cutting edge facing away from the opening, to be used as a guide for cutting the new hole. The hole saw with the larger diameter for the new hole would be mounted in a conventional manner in the hole saw arbor. A special hushing nut is provided for use on the threaded end of the adaptor when the smaller diameter hole saw has a larger mounting aperture than the adaptor.

Furthermore, Bristow, in U.S. Pat. No. 5,413,437, discloses a double arbor that has a shaft with a slideable first arbor at one end and a fixed second arbor at the other. A first hole saw of the already-cut, incorrect diameter is mounted on the first arbor. A second hole saw which is the size of the desired diameter hole is mounted on the second arbor. The assembly is attached to a drill or other rotating driving means and the first hole saw is placed into the existing opening where it acts as a pilot bit for the second hole saw. Use of the first hole saw as a pilot can also be applied to rabbeting, bevelling, grooving or sanding the existing hole by attaching different blades in place of the second hole saw.

What is needed is a hole cutter and guide that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available hole cutters and guides. According to one embodiment of the present invention is a hole cutter and guide for cutting holes or countersinking with a guide comprising: a bit portion, upon which may be mounted a first hole saw, a spacer portion, and a second hole saw.

The bit portion may include a center shaft which includes a drilling portion, and on the center shaft is mounted a post base from which a post extends parallel to the center shaft, and which is moveable on the center shaft in a direction of an axis of the center shaft, and having a diameter greater than that of the center shaft, a pass through collar through which the post passes, and which is fixed to the center shaft so as not to be moveable thereon, and having a diameter of greater than that of the center shaft, and a threaded portion opposite of the pass through collar from the post base, fixed to the center shaft so as not to be moveable thereon, and having a diameter of greater than that of the center shaft, and less than that of the pass through collar such that the post does not touch the threaded portion.

The first hole saw may include a cutting surface, a threaded hole couplable with the threaded portion, a post hole couplable with the post, and a vent hole. The spacer portion may include an outer diameter that fits within the first hole saw, an inner diameter which fits over the second hole saw, and a thumb screw that passes through the vent hole. The second hole saw may include a cutting surface, a threaded hole couplable with the threaded portion, and a post hole couplable with the post. The threaded portion may include a portion of larger diameter couplable with the threaded hole of the first hole saw, and a portion of a smaller diameter couplable with the threaded hole of the second hole saw, and wherein the diameters of both portions of the threaded portion are larger than the diameter of the center shaft. The hole cutter and guide may further include a total of four posts, and wherein the first hole saw, spacer portion, and second hole saw include a total of four post holes each. The spacer portion may include a total of four post holes.

According to another embodiment, the present invention includes a hole cutter and guide kit having component parts capable of being assembled in the field, the kit comprising the combination of a bit portion, which includes a center shaft which includes a drilling portion, and on the center shaft is mounted a post base from which a post extends parallel to the center shaft, and which is moveable on the center shaft in a direction of an axis of the center shaft, and having a diameter greater than that of the center shaft, a pass through collar through which the post passes, and which is fixed to the center shaft so as not to be moveable thereon, and having a diameter of greater than that of the center shaft, and a threaded portion opposite of the pass through collar from the post base, fixed to the center shaft so as not to be moveable thereon, and having a diameter of greater than that of the center shaft, and less than that of the pass through collar such that the post does not touch the threaded portion, a plurality of first hole saws which each include a cutting surface, a threaded hole couplable with the threaded portion, a post hole couplable with the post, and a vent hole, wherein diameters of the first hole saws are different, a plurality of second hole saws, which each include a cutting surface, a threaded hole couplable with the threaded portion, and a post hole couplable with the post, wherein diameters of the second hole saws are different, and all diameters of the second hole saws are smaller than the diameters of the first hole saws, and a plurality of spacer portions, wherein a number of the spacer portions is equal to a number of the first hole saws multiplied by a number of the second hole saws, each of which include a thumb screw that passes through the vent hole of any of the first hole saws, a post hole couplable with the post, and each of which includes an outer diameter and an inner diameter commensurate with the diameters of the first and second hole saws.

According to yet another embodiment of the present invention is a hole cutter and guide kit having component parts capable of being assembled in the field, the kit comprising the combination of a bit portion, which includes a center shaft which includes a drilling portion, and on the center shaft is mounted a post base from which a post extends parallel to the center shaft, and which is moveable on the center shaft in a direction of an axis of the center shaft, and having a diameter greater than that of the center shaft, a pass through collar through which the post passes, and which is fixed to the center shaft so as not to be moveable thereon, and having a diameter of greater than that of the center shaft, and a threaded portion opposite of the pass through collar from the post base, fixed to the center shaft so as not to be moveable thereon, and having a diameter of greater than that of the center shaft, and less than that of the pass through collar such that the post does not touch the threaded portion, two first hole saws which each include a cutting surface, a threaded hole couplable with the threaded portion, a post hole couplable with the post, and a vent hole, wherein diameters of the two first hole saws are different, two second hole saws, which each include a cutting surface, a threaded hole couplable with the threaded portion, and a post hole couplable with the post, wherein diameters of the two second hole saws are different, and each are smaller than the diameters of the two first hole saws, four spacer portions, each of which include a thumb screw that passes through the vent hole of any of the first hole saws, a post hole couplable with the post, and two of which have an outer diameter that fits within one of the first hole saws, and each of which have inner diameters of different sizes, one to fit over one of the second hole saws, the other to fit over the second hole saw, and two of which have an outer diameter that fits within the other of the first hole saws, and each of which have inner diameters of different sizes, one to fit over one of the second hole saws, the other to fit over the second hole saw.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates an exploded perspective view of the hole cutter and guide according to one embodiment of the present invention;

FIG. 2 illustrates a perspective view of the bit portion of the hole cutter and guide according to one embodiment of the present invention; and

FIG. 3 illustrates a perspective view of the spacer according to one embodiment of the present invention.

FIG. 4 illustrates an exploded perspective view of the hole cutter and guide according to one embodiment of the present invention.

FIG. 5 illustrates a perspective view of the hole cutter and guide according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

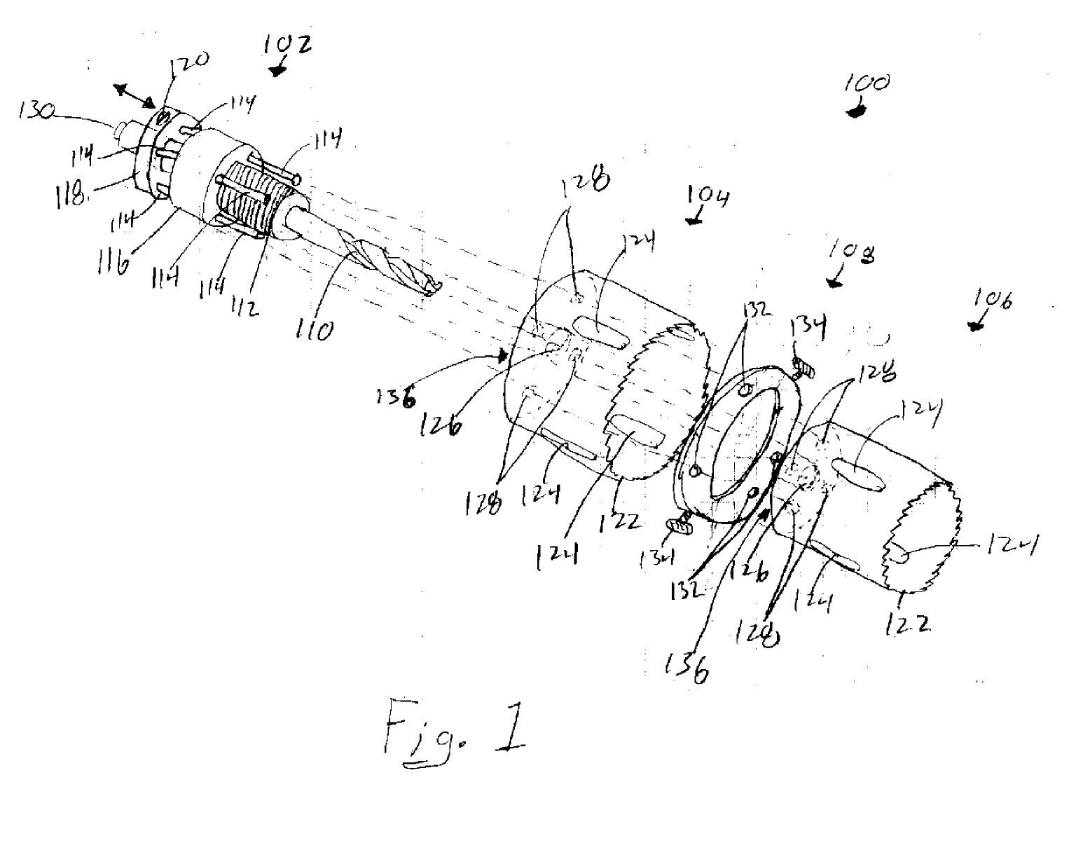

FIG. 1 illustrates an exploded view of the hole cutter and guide 100 according to one embodiment of the present invention. The hole cutter and guide 100 according to this embodiment includes four portions, namely, a bit portion 102, a first hole saw 104, a spacer portion 108, and a second hole saw 106. The four portions of the hole cutter and guide 100 fit together as illustrated in FIG. 1.

The bit portion 102 of the hole cutter and guide 100 is the portion that may be connected to a rotating apparatus such as a power drill, a hand drill, or so forth. Any apparatus capable of turning the hole cutter and guide 100 about its axis of rotation may be used.

The bit portion includes a center shaft 130 about which is the axis of rotation. The center shaft 130 may be cylindrical in shape. The bit portion may include a drilling portion 110 capable of drilling a hole. The bit portion 110 may be cylindrical in shape. The drilling portion 110 may be coaxial with the center shaft 130. The drilling portion 110 and the center shaft 130 may be formed from the same piece of material. About the center shaft 130 and/or the drilling portion 110 may be a threaded portion 112. The threaded portion 112 may have a greater diameter than the drilling portion 110 and/or the center shaft 130. The threaded portion 112 may be cylindrical in shape. The threaded portion 112 may be substantially static in relation to the center shaft 130 and/or the drilling portion 112 whether the hole cutter and guide 100 is in use or not.

Proximate to the threaded portion 112 is a pass-through collar 116. The pass-through collar 116 may be cylindrical in shape, and may have a diameter greater than the center shaft 130, the drilling portion 110, and/or the threaded portion 112. The pass through collar 116 may be static in relation to the threaded portion 112, the drilling portion 110, and/or the center shaft 130. A post 114 may pass through the pass through collar 116 through a hole in the pass through collar 118. The post 114 may be moveable through the pass through collar 114 along the axis of rotation, and relative to the pass through collar 118, the center shaft 130, the threaded portion 112, and/or the drilling portion 110. In one embodiment there is a single post 114. According to another embodiment, there are two posts 114. According to yet another embodiment there are three posts 114. According to yet another embodiment, there are four posts 114. According to yet another embodiment, there are five posts 114. According to yet another embodiment, there are multiple posts 114.

The post 114 may be attached to a post base 118 located on the center shaft 130 opposite of the pass through collar 116 from the threaded portion 112. the post base 118 may be in the shape of a disc, and may have a diameter substantially the same as the pass through collar 116. The post base 118 may be moveable in the same direction as the post 114, so that the distance that the post 114 passes through the pass through collar 116 may be changed. The post base 118 may also include a lock screw 120. When the lock screw 120 is tightened, the post base 118 may be substantially inhibited from moving in a direction along the axis of rotation, or around the axis of rotation. The lock screw 120 may tighten against the center shaft 130. The lock screw 120 may tighten into a divot in the center shaft 130 designed to accept the lock screw 120.

The first hole saw 104 may be substantially cylindrical in shape, with a first end 136 substantially perpendicular to the cylinder walls. It may also include another end being formed so as to be capable of cutting upon rotation, thus forming a cutting edge 122. Along the cylinder walls may be a vent hole 124. According to another embodiment, there are at least as many vent holes 124 as there are thumb screws 134 on the spacer portion, described hereinafter.

The first hole saw 104 may include post holes in the first end 136. The post holes 136 may be configured to allow the posts 114 to pass through the post holes 136. Further, the post holes 136 may be configured to fit snuggly against the posts 114 when the posts 114 are within the post holes 136. In one embodiment, the first hole saw 104 includes at least as many post holes 136 as the bit portion 102 includes posts, aligning with the posts 114 so that the posts 114 may pass through the first hole saw 104. The first end 136 may also include a hole 126 configured such that the drilling portion 110 may pass therethrough. The hole 126 may also be threaded such that it may be coupled with the threaded portion 112.

In one embodiment, the attachment of the first hole saw 104 to the bit portion 102 includes loosening the lock screw 120, moving the post base away from the pass through collar 116 such that the length of the posts 114 passing through the pass through collar 116 is reduced, and coupling the first hole saw 104 to the threaded portion 112 by contacting the hole 126 to the threaded portion 112 and rotating it in the correct direction until it reaches the desired location on the threaded portion 112. The post base 118 may then be moved toward the pass through collar 116 such that the posts 114 pass through the post holes 128 in the first hole saw, and the lock screw tightened.

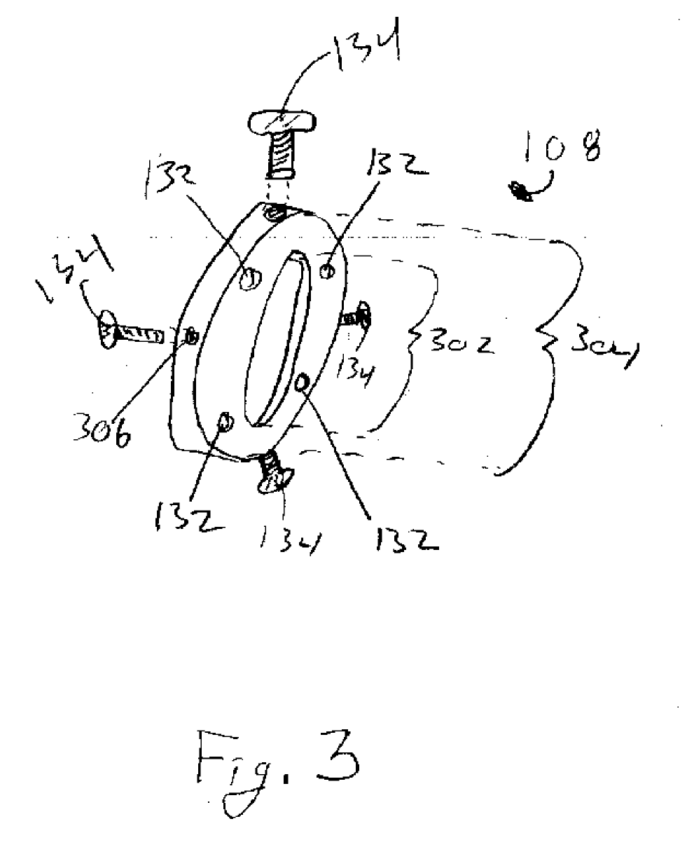

The hole cutter and guide 100 may be used as thus put together with the drilling portion 110 being used as the guide. Alternatively, a second hole saw portion 106, and/or a spacer portion 108 may be installed. The spacer portion 108 is also illustrated in FIG. 3. The spacer portion 108 may include an inner diameter 302 and an outer diameter 304. The outer diameter 304 may be configured to fit within the first hole saw 104, and the inner diameter may be configured to fit around the second hole saw 106. The spacer portion 108 may include post holes 132. The number of post holes 132 may be at least as great as the number of posts 114 in the bit portion, and in a configuration such that the posts 114 fit through the post holes 132, and may fit snuggly therein. The spacer portion 108 may include thumb screws 134. The thumb screws 134 may be threaded. The thumb screws 134 may fit and screw into thumb screw holes 306 in the spacer portion 108. The thumb screw holes 306 may be in a configuration to match with the vent holes 124 of the first hole saw 104.

After the first hole saw 104 is installed (see above) onto the bit portion 102, the spacer portion 108 may be installed. With the thumb screws 134 removed, the spacer portion 108 may be placed into the first hole saw 104, such that the post holes align with the posts 114, and fit over the posts 114. The spacer portion 108 may be installed to whatever depth in the first hole saw 104 is desired. The thumb screws 134 may be inserted into the thumb screw holes 306 and tightened until they fit snuggly against the first hole saw 104 such that the spacer portion 108 is substantially static relative to the first hole saw 104.

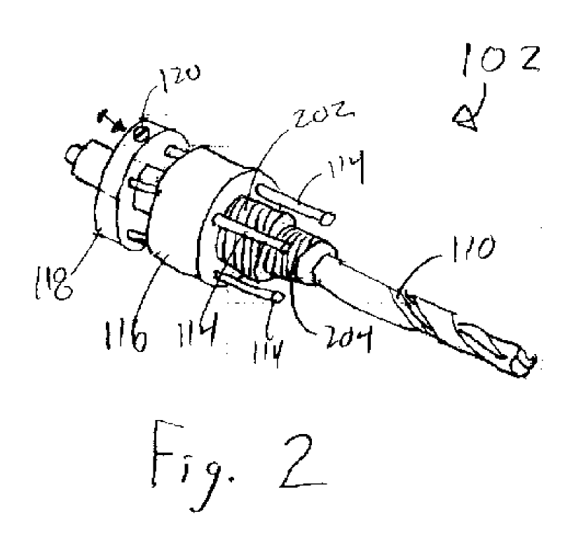

A second hole saw 106, configured substantially the same as the first hole saw 104 may also be installed into the hole cutter and guide 100. In one embodiment, the hole 126 of the second hole saw 106 is of an equal diameter as the hole 126 of the first hole saw 104. In another embodiment, the hole 126 of the second hole saw 106 is of a smaller diameter than the hole 126 of the first hole saw 104. This second embodiment may work especially well with the bit portion 102 illustrated in FIG. 2. The bit portion 102 illustrated in FIG. 2 illustrates a bit portion 102 with a first threaded portion 202 and a second threaded portion 204. The first threaded portion 202 is coupleable with the first hole cutter 104, and the second threaded portion 204 is coupleable with the second hole cutter 106.

The second hole saw 106 may be installed after the first hole saw 104 and optionally the spacer portion 108 are installed onto the bit portion 102. The lock screw 120 may be loosened, if it was tightened, and the post base 118 moved away from the pass through collar 116 until the posts 114 do not pass completely through the spacer portion 108, if it is installed, or the first hole saw 104 if no spacer portion 108 is installed. The second hole cutter 106 may then be placed onto the threaded portion 112, 204 and rotated until it stops at the spacer portion 108 or the first hole cutter 104, and the post holes 128 are aligned with the post holes 132 of the spacer portion 108 and/or the first hole saw 104 and the posts 114. The post base 118 may then be moved toward the pass through collar 116 until the posts 114 pass through the post holes 128 of the first hole saw 104, the post holes 132 of the spacer portion 108 if it is installed, and the post holes 128 of the second hole saw. The lock screw 120 may then be tightened such that the post base 118 and posts are relatively static in relation to the pass through collar 116.

In one embodiment, the cylindrical length of the second hole saw 106 is longer than that of the first hole saw 104 such that when both are installed, the second hole saw 106 may serve as a guide through the medium being cut for the first hole saw 104. The drilling portion 110 may extend through all of the first hole saw 104, the spacer portion 108, and the second hole saw 106.

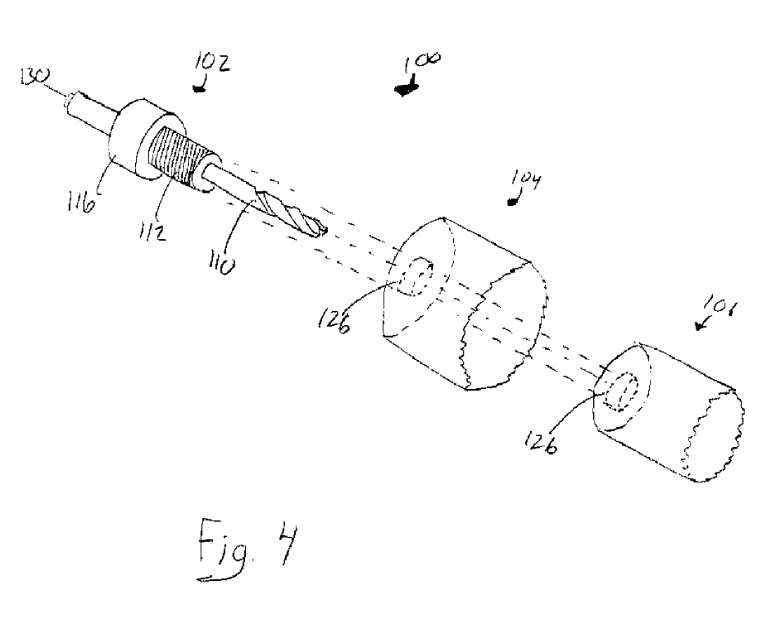

Another embodiment is illustrated in FIG. 4. In this illustrated embodiment, the hole saw 100 includes a bit 102, a first hole saw 104 and a second hole saw 106. The bit 102 includes a threaded portion 112, a pass-through 116, and a center shaft 130, as herein described. The pass-through 116 of the present embodiment may be solid. The first hole saw 104 may include a threaded section 126 that couples with the threaded portion 112 of the bit 102. The second hole saw 106 may also include a threaded section 126 that couples with the threaded portion 112 of the bit 102. The second hole saw 106 may fit into the first hole saw 104.

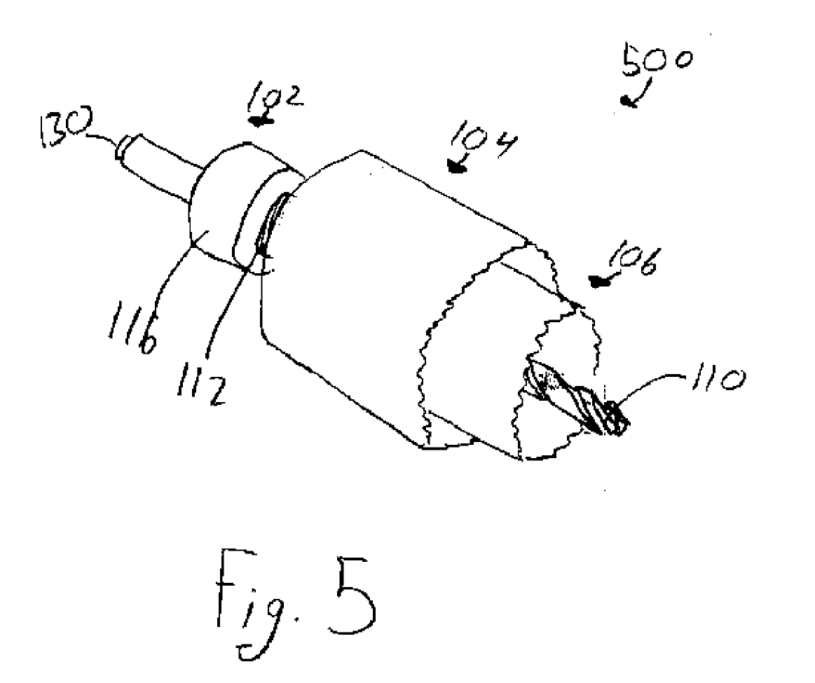

FIG. 5 illustrates the hole saw 500 according to one embodiment of the present invention. The hole saw 500 is illustrated as mounted together. The first hole saw 104 and second hole saw 106 are mounted to the bit 102 by coupling the threaded sections 126 of the first 104 and second 106 hole saws to the threaded portion 112 of the bit 112. The threaded sections 126 may be screwed completely to the bit 102 such that the first hole saw 104 contacts the pass-through 116. The second hole saw 106 may be screwed completely to the bit 102 such that the second hole saw 106 contacts the first hole saw 104 at the threaded sections 126 of the hole saws 104, 106. Further, the first and second hole saws 104, 106 may be mounted and twisted against each other such that pressure between the threaded sections 126 of the first and second hole saws 104, 106 is sufficient to resist the hole saws 104, 106 from becoming dismounted from the bit 102. That is, after the first and second hole saws 104, 106 have been screwed on to the threaded portion 112 until they are touching, the first hole saw 104 can be unscrewed such that it moves toward the second hole saw 106, and/or the second hole saw 106 can be further screwed on such that it moves toward the first hole saw 104. This mounting can cause pressure between the two hole saws 104, 106 such that they resist twisting and unscrewing in use.

In yet another embodiment, the present invention includes a kit of for hole cutters and guides 100. The kit includes a plurality of bit portions 102, a plurality of first hole saw portions 104, a plurality of spacer portions 108, and a plurality of second hole cutters 106. The number of spacer portions 108 is equal to the number of possible combinations of first hole saws 104 and second hole saws 106, minus the number of combinations of where the diameter of the first hole saws 104 is less than the number of second hole saws 106. The sizes of the spacer portions 108 is commensurate such that the outer diameters of the spacer portions 304 are equal to interior diameters of the first hole saws 104, and the inner diameters of the spacer portions 302 are equal to the exterior diameters of the second hole saws 106. The bit portions 102 may include drilling portions 110 with different diameters each.

In one embodiment, the kit includes a plurality of bit portions 102 with drilling portions 110 of diameters from 0.8 mm to about 25 mm. The kit also includes a number of first hole saws 104 with inner diameters of from about 25 mm to about 150 mm. The kit also includes a number of second hole saws 106 with outer diameters of from about 25 mm to about 150 mm. The kit also includes a number of spacer portions 108 with inner diameters 302 and outer diameters 304 commensurate with the possible combinations of first and second hole saws 104, as described above. One example of such a kit is illustrated in Table 1. This example is not meant to be limiting to the claims.

TABLE 1
Example of Components of a Kit

| | | | Second | | Spacer | Spacer |
|---|---|---|---|---|---|---|
| Drilling | First Hole | First Hole | Hole Saws | Second | Portions | Portions |
| Portions | Saws | Saws | Outer | Hole Saws | Outer | Inner |
| Diameters | Inner Diameter | Length | Diameter | Length | Diameter | Diameter |
| (mm) | (mm) | (mm) | (mm) | (mm) | (mm) | (mm) |
| 1 | 40 | 25 | 25 | 35 | 80 | 25 |
| 5 | 60 | 25 | 45 | 35 | 80 | 45 |
| 10 | 80 | 25 | 65 | 35 | 80 | 65 |
| 15 | | | | | 60 | 45 |
| 20 | | | | | 60 | 25 |
| 25 | | | | | 40 | 25 |

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, the different components may be made of any suitable material, such as, for example, metal, composite, plastic, ceramic, combinations thereof, and so forth.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A hole cutter and guide assembly for cutting holes or countersinking with a guide comprising: a bit portion, upon which is mounted a first hole saw, and a second hole saw.

2. The hole cutter and guide of claim 1, further comprising a spacer mounted to the bit portion.

3. The hole cutter and guide of claim 2, wherein the bit portion includes:
a center shaft which includes a drilling portion, and on the center shaft is mounted a post base from which a post extends parallel to the center shaft, and which is moveable on the center shaft in a direction of an axis of the center shaft, and having a diameter greater than that of the center shaft;
a pass through collar through which the post passes, and which is fixed to the center shaft so as not to be moveable thereon, and having a diameter of greater than that of the center shaft; and
a threaded portion opposite of the pass through collar from the post base, fixed to the center shaft so as not to be moveable thereon, and having a diameter of greater than that of the center shaft, and less than that of the pass through collar such that the post does not touch the threaded portion.

4. The hole cutter and guide of claim 3, wherein the first hole saw includes a cutting surface, a threaded hole couplable with the threaded portion, a post hole couplable with the post, and a vent hole.

5. The hole cutter and guide of claim 4, wherein the spacer portion includes an outer diameter that fits within the first hole saw, an inner diameter which fits over the second hole saw, and a thumb screw that passes through the vent hole.

6. The hole cutter and guide of claim 4, wherein the second hole saw includes a cutting surface, a threaded hole couplable with the threaded portion, and a post hole couplable with the post.

7. The hole cutter and guide of claim 6, wherein the threaded portion includes a portion of larger diameter couplable with the threaded hole of the first hole saw, and a portion of a smaller diameter couplable with the threaded hole of the second hole saw, and wherein the diameters of both portions of the threaded portion are larger than the diameter of the center shaft.

8. The hole cutter and guide of claim 6, further comprising a total of four posts, and wherein the first hole saw, spacer portion, and second hole saw include a total of four post holes each.

9. The hole cutter and guide of claim 8, wherein the spacer portion includes a total of four post holes.

10. A hole cutter and guide kit having component parts capable of being assembled in the field, the kit comprising the combination of:
a bit portion, which includes:
a center shaft which includes a drilling portion, and on the center shaft is mounted a post base from which a post extends parallel to the center shaft, and which is moveable on the center shaft in a direction of an axis of the center shaft, and having a diameter greater than that of the center shaft;
a pass through collar through which the post passes, and which is fixed to the center shaft so as not to be moveable thereon, and having a diameter of greater than that of the center shaft; and
a threaded portion opposite of the pass through collar from the post base, fixed to the center shaft so as not to be moveable thereon, and having a diameter of greater than that of the center shaft, and less than that of the pass through collar such that the post does not touch the threaded portion;
a plurality of first hole saws which each include a cutting surface, a threaded hole couplable with the threaded portion, a post hole couplable with the post, and a vent hole, wherein diameters of the first hole saws are different;
a plurality of second hole saws, which each include a cutting surface, a threaded hole couplable with the threaded portion, and a post hole couplable with the post, wherein diameters of the second hole saws are different, and all diameters of the second hole saws are smaller than the diameters of the first hole saws; and
a plurality of spacer portions, wherein a number of the spacer portions is equal to a number of the first hole saws multiplied by a number of the second hole saws, each of which include a thumb screw that passes through the vent hole of any of the first hole saws, a post hole couplable with the post, and each of which includes an outer diameter and an inner diameter commensurate with the diameters of the first and second hole saws.

11. A hole cutter and guide kit having component parts capable of being assembled in the field, the kit comprising the combination of:
a bit portion, which includes:
a center shaft which includes a drilling portion, and on the center shaft is mounted a post base from which a post extends parallel to the center shaft, and which is moveable on the center shaft in a direction of an axis of the center shaft, and having a diameter greater than that of the center shaft;
a pass through collar through which the post passes, and which is fixed to the center shaft so as not to be moveable thereon, and having a diameter of greater than that of the center shaft; and
a threaded portion opposite of the pass through collar from the post base, fixed to the center shaft so as not to be moveable thereon, and having a diameter of greater than that of the center shaft, and less than that of the pass through collar such that the post does not touch the threaded portion,
two first hole saws which each include a cutting surface, a threaded hole couplable with the threaded portion, a post hole couplable with the post, and a vent hole, wherein diameters of the two first hole saws are different,
two second hole saws, which each include a cutting surface, a threaded hole couplable with the threaded portion, and a post hole couplable with the post, wherein diameters of the two second hole saws are different, and each are smaller than the diameters of the two first hole saws,
four spacer portions, each of which include a thumb screw that passes through the vent hole of any of the first hole saws, a post hole couplable with the post, and
two of which have an outer diameter that fits within one of the first hole saws, and each of which have inner diameters of different sizes, one to fit over one of the second hole saws, the other to fit over the second hole saw, and
two of which have an outer diameter that fits within one of the first hole saws, and each of which have inner diameters of different sizes one to fit over one of the second hole saws, the other to fit over the second hole saw.
